(19) United States
(12) Patent Application Publication
(10) Pub. No.: US 2011/0256410 A1
(43) Pub. Date: Oct. 20, 2011

(54) FIRE-RESISTANT LAMINATED GLASS

(76) Inventor: MAO SHENG WU, TAIPEI CITY (TW)

(21) Appl. No.: 12/759,911

(22) Filed: Apr. 14, 2010

(51) Int. Cl. B32B 17/10

(52) U.S. Cl. 428/437

(57) ABSTRACT

An improvement of fire-resistant laminated glass is provided, which serves to retard spreading fire and high heat in conflagration, and normally acts as crashworthy glass, wherein plural potash glass sheets are bound as a whole by means of PVB (polyvinyl butyral) and form the laminated glass, in which the PVB reinforces the potash glass by multiplying a crashworthiness thereof and the potash glass, as a product of processing soda-lime glass with the known chemical enhanced treatment, is high-temperature endurable.

### BACKGROUND OF THE INVENTION

1. Technical Field

The present invention relates to structures of laminated glass, and more particularly, to a kind of fire-resistant laminated glass.

2. Description of Related Art

Soda-lime glass, which is currently extensively used in public facilities, when burned to a temperature in excess of 360° C. can burst and when further heated to 900° C. can even melt, thus being an underlying threat to public safety.

In conflagration, the blaze may quickly achieve high heat unbearable to the conventional soda-lime glass, and the bursting glass significantly increases the difficulty for escapees in escaping from the scene of fire and decreasing the possibility of victims' survival. Besides, once soda-lime glass in scene of fire bursts, fire can spread more quickly and become more unextinguishable.

Fire-resistant glass has been therefore developed. There is a kind of fire-resistant glass as laminated glass loaded therein with a fire-retardant agent and is proven effective in fire retardant. However, a fire-retardant agent is always subject to a limited storage life. In addition, fire-retardant agents are usually sensitive to ambient heat, such as that caused by sunshine, and tend to deteriorate as well as premature nullification. All these pose the existing fire-resistant glass being only acceptable for indoor use but not ideal to outdoor applications.

In view of the fact that conventional soda-lime glass is less heat-tolerant and consequently the quick spreading fire can shorten the rescue time as well as the fact that the existing agent-based fire-resistant glass is limited in applications due to its sensitivity to the sunshine, and in storage life, the inventor of the present invention, with his years of experience in this art, repeatedly researched and finally invented the herein disclosed laminated glass that is fire resistant, high-heat resistant, and adaptive to both indoor as well as outdoor applications.

### SUMMARY OF THE INVENTION

The present invention provides an improvement of fire-resistant laminated glass, which serves to retard spreading fire and high heat in conflagration, and normally acts as crashworthy glass, wherein plural potash glass sheets are bound as a whole by means of PVB (polyvinyl butyral) and form the laminated glass, in which the PVB reinforces the potash glass by multiplying a crashworthiness thereof and the potash glass, as a product of processing soda-lime glass with the known chemical enhanced treatment, is high-temperature endurable.

Thus, it is an objective of the present invention to provide an improved structure of laminated potash glass sheets so that the laminated glass serves to retard spreading fire and high heat in conflagration, and normally acts as safe glass that is crashworthy and burstproof.

### BRIEF DESCRIPTION OF THE DRAWINGS

The invention as well as a preferred mode of use, further objectives and advantages thereof will be best understood by reference to the following detailed description of an illustrative embodiment when acquire in conjunction with the accompanying drawings, wherein:

FIG. 1 is an exploded view of improved fire-resistant laminated glass according to the present invention;

FIG. 2 is a perspective view of the improved fire-resistant laminated glass according to the present invention; and

FIG. 3 is a schematic drawing showing the improved fire-resistant laminated glass of the present invention in fire.

### DETAILED DESCRIPTION OF THE INVENTION

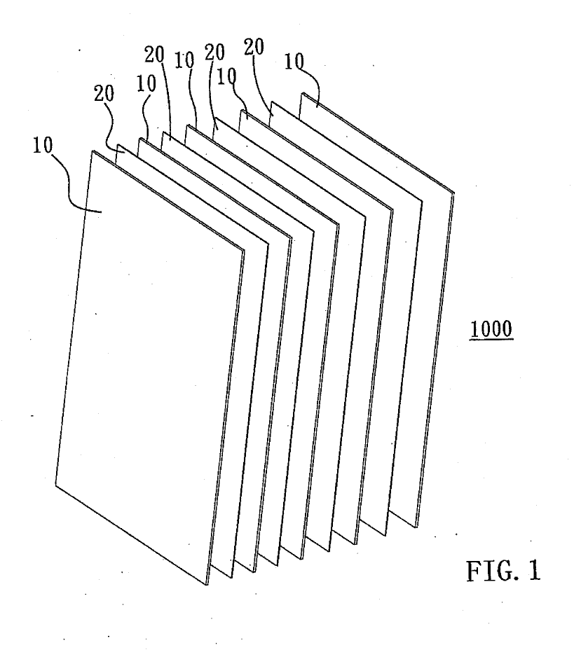

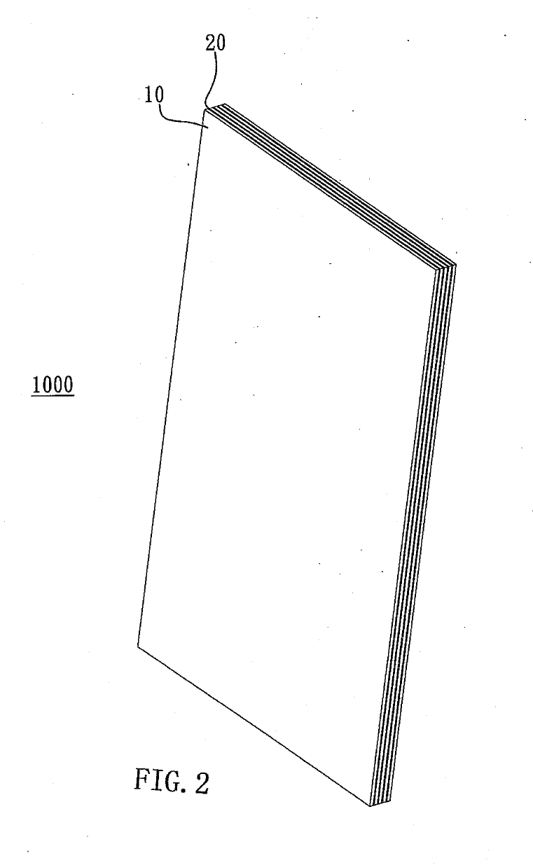

FIG. 1 is an exploded view of improved fire-resistant laminated glass according to the present invention. As shown, plural potash glass sheets 10 are bound as a whole by means of PVB (polyvinyl butyral) 20 so as to form a piece of fire-resistant laminated glass 1000 as depicted in FIG. 2.

Therein, the potash glass sheets 10 have received chemical enhanced treatment so as to be endurable to a high temperature of about 1000° C. and not to burst in high heat when receiving equal thermal expansion pressures at two opposite surfaces thereof.

The fire-resistant laminated glass 1000 composed of the potash glass sheets 10 bound as a whole by means of PVB (polyvinyl butyral) 20 has multiplied strength and is made to be crashworthy and burstproof.

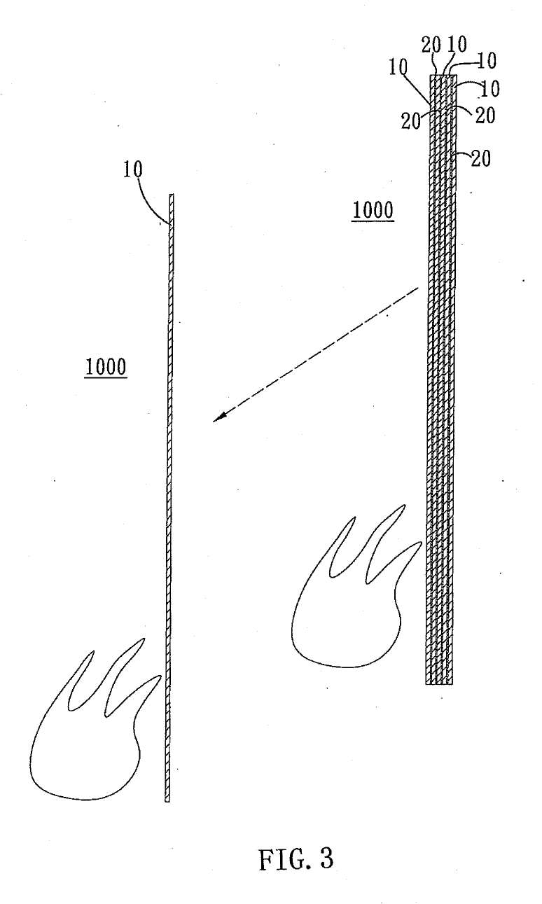

FIG. 3 is a schematic drawing showing the improved fire-resistant laminated glass of the present invention in fire. As shown, the fire-resistant laminated glass 1000, when burned in fire, the PVB (polyvinyl butyral) 20, which has a melt point at about 100° C., as layers between two adjacent said potash glass sheets 10 can start to melt ahead of the potash glass sheets 10 and leave a space between the potash glass sheets 10. The space can expand under heat and provides a thermal expansion pressure coefficient to the adjacent glass sheet 10 different from a thermal expansion pressure coefficient applied by the fire to fire-contacting surface of the potash glass sheet 10. As a result, the potash glass sheet 10 directly getting heated by the fire breaks. In the same manner, the potash glass sheets 10, which are successively in direct contact with the fire, break one after another under unbalanced thermal expansion pressures at the opposite surfaces thereof. Finally, the last potash glass sheet 10 remaining intact receives balanced thermal expansion pressures at the opposite surfaces thereof and thus maintains intact up to about 1000° C. The last survived potash glass sheet 10 effectively retards the fire from spreading so as to control the damage and facilitate rescue.

From the above it is learned that the disclosed fire-resistant laminated glass 1000 is exactly endurable to high heat of about 1000° C. and capable of retarding fire as it does not crumble in fire. Therefore, a prolonged rescue time is allowable because the last survived potash glass sheet 10 of the fire-resistant laminated glass 1000 can effectively retard the fire from spreading so as to ensure the safety of the escapees, or rescuer and rescuees.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An improvement of fire-resistant laminated glass, the improvement laying on that a plurality of potash glass sheets are bound as a whole by means of PVB (polyvinyl butyral) and form the fire-resistant laminated glass.

2. The improvement of fire-resistant laminated glass of claim 1, wherein the potash glass sheets are a product of processing soda-lime glass sheets with a chemical enhanced treatment so as to be endurable to a high temperature of about 1000° C. and not to burst in high heat when receiving equal thermal expansion pressures at two opposite surfaces thereof.

3. The improvement of fire-resistant laminated glass of claim 1, wherein the PVB that binds the potash glass sheets multiplies a strength of the potash glass sheets and allows the potash glass sheets to be normally crashworthy and burstproof.
